(19) United States
(12) Patent Application Publication
(10) Pub. No.: US 2026/0332431 A1
(43) Pub. Date: Oct. 22, 2026

(54) Governance-Conditioned Memory Evolution Architecture Using Authoritative Memory States, Signed Delta-State Relationships, and Future Authoritative Memory-State Formation

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 19/703,863

(22) Filed: Jun. 10, 2026

(51) Int. Cl. H04L 9/32

(52) U.S. Cl. CPC H04L 9/3247

(57) ABSTRACT

A governance-conditioned memory evolution architecture is disclosed. One or more authoritative memory states are established according to governance-conditioned admissibility relationships. One or more signed delta-state relationships are determined relative to the authoritative memory states. Associations are generated according to the signed delta-state relationships, and governance relationships are determined according to the associations and the signed delta-state relationships. Governance-conditioned memory structures are formed according to the governance relationships. Admissibility relationships determine participation within memory-evolution relationships. Memory evolution occurs according to governance-conditioned participation relationships associated with authoritative memory states, signed delta-state relationships, associations, governance relationships, memory structures, continuity relationships, and lineage relationships. Future authoritative memory states are established according to governance-conditioned memory evolution relationships. The architecture preserves memory as a governance-conditioned operational reality capable of continuity preservation, lineage preservation, admissibility determination, and future authoritative memory-state formation.

### CROSS-REFERENCE TO RELATED APPLICATIONS

This application claims priority to and benefit of any applicable prior-filed applications identified in the application data sheet, including applications associated with governance-conditioned memory architectures, authoritative state architectures, continuity-preserving memory architectures, lineage-preserving architectures, admissibility-governed architectures, memory evolution architectures, and related applications, the disclosures of which are incorporated herein by reference to the extent permitted by applicable law.

### PRIOR ART

The following references are provided as prior art references for information disclosure purposes. Inclusion of any reference does not constitute an admission that the reference is material, relevant, analogous, enabling, anticipatory, obvious, or otherwise applicable to any claim of the present application.

The listed references are provided to assist review of technologies associated with checkpoint architectures, state-machine architectures, distributed-state architectures, memory architectures, retrieval-augmented systems, explainable artificial intelligence systems, continual-learning systems, provenance architectures, knowledge-graph systems, event-sourcing systems, orchestration systems, intent-based operational systems, autonomous systems, machine-learning systems, and related operational infrastructures.

The Applicant expressly reserves the right to distinguish, amend, supplement, remove, replace, combine, or otherwise address any reference during prosecution.

The references are listed in a neutral disclosure format and are not presented in any order of relevance, materiality, chronology, similarity, importance, or applicability.

U.S. PATENT DOCUMENTS

| | |
|---|---|
| U.S. Pat. No. 8,880,941 B1 | November 2014 Reiss et al. |
| U.S. Pat. No. 8,135,987 B2 | March 2012 Douceur et al. |
| U.S. Pat. No. 10,460,130 B1 | October 2019 Chhabra |
| U.S. Pat. No. 11,354,445 B2 | June 2022 Chhabra |
| U.S. Pat. No. 11,429,379 B2 | August 2022 Jain et al. |
| U.S. Pat. No. 7,801,852 B2 | September 2010 Wong et al. |
| U.S. Pat. No. 10,901,957 B2 | January 2021 Natarajan et al. |
| U.S. Pat. No. 2021/0319340 A1 | October 2021 Shabtay et al. |
| U.S. Pat. No. 2018/0330238 A1 | October 2018 Luciw et al. |
| U.S. Pat. No. 11,003,865 B1 | May 2021 Lee et al. |
| U.S. Pat. No. 2024/0346256 A1 | October 2024 Qin |
| U.S. Pat. No. 11,615,331 B2 | March 2023 Li et al. |
| U.S. Pat. No. 10,007,513 B2 | June 2018 Malladi et al. |
| U.S. Pat. No. 9,882,833 B2 | January 2018 Mcbride et al. |
| U.S. Pat. No. 10,250,525 B2 | April 2019 Mcbride et al. |
| U.S. Pat. No. 10,673,777 B2 | June 2020 Mcbride et al. |
| U.S. Pat. No. 10,862,822 B2 | December 2020 Bugenhagen et al. |
| U.S. Pat. No. 10,203,701 B2 | February 2019 Kurdi et al. |
| U.S. Pat. No. 11,544,470 B2 | January 2023 Zhang et al. |
| U.S. Pat. No. 2012/0158633 A1 | June 2021 Eder |
| U.S. Pat. No. 2016/0164884 A1 | June 2016 Sriram et al. |
| U.S. Pat. No. 2022/0245470 A1 | August 2022 Acharya et al. |
| U.S. Pat. No. 11,836,600 B2 | December 2023 Baker et al. |
| U.S. Pat. No. 11,645,095 B2 | May 2023 Kumar et al. |
| U.S. Pat. No. 11,216,444 B2 | January 2022 Busjaeger et al. |
| U.S. Pat. No. 11,341,000 B2 | May 2022 Smith-Uchida et al. |
| U.S. Pat. No. 11,238,065 B1 | February 2022 Tang |
| U.S. Pat. No. 11,948,063 B2 | April 2024 Baker et al. |
| U.S. Pat. No. 12,205,010 B2 | January 2025 Baker et al. |
| U.S. Pat. No. 9,996,595 B2 | June 2018 Bond |
| U.S. Pat. No. 10,007,674 B2 | June 2018 Fink et al. |
| U.S. Pat. No. 10,956,510 B2 | March 2021 Boxwell et al. |
| U.S. Pat. No. 11,531,817 B2 | December 2022 Aditya et al. |
| U.S. Pat. No. 2023/0267338 A1 | August 2023 Kotnis et al. |

### BACKGROUND OF THE INVENTION

Conventional information-processing systems frequently treat memory as storage of data values, records, documents, vectors, embeddings, retrieved content, generated content, or combinations thereof. Existing systems often preserve information according to storage relationships, retrieval relationships, indexing relationships, database relationships, language relationships, computation relationships, or combinations thereof.

Many existing systems do not distinguish authoritative memory states from temporary observations, transient computations, generated outputs, inferred outputs, retrieved outputs, or candidate outputs. As a result, subsequent operational participation may occur without clear governance-conditioned admissibility determination, continuity preservation, lineage preservation, or memory-evolution determination.

Artificial-intelligence systems, large language models, retrieval-augmented systems, agent systems, simulation systems, autonomous systems, industrial systems, and other operational systems frequently generate outputs, recommendations, predictions, interpretations, or combinations thereof. However, generated outputs do not necessarily constitute authoritative memory states capable of participating in subsequent operational realities.

Conventional approaches frequently replace previous states with subsequent states without preserving governance-conditioned memory evolution relationships. Such approaches may fail to preserve continuity relationships, lineage relationships, signed delta-state relationships, admissibility relationships, governance relationships, or combinations thereof.

Accordingly, there exists a need for architectures capable of establishing authoritative memory states, determining signed delta-state relationships relative to authoritative memory states, generating associations according to signed delta-state relationships, forming governance-conditioned memory structures, determining admissibility, preserving continuity and lineage, supporting memory evolution, and establishing future authoritative memory states according to governance-conditioned memory evolution relationships.

### SUMMARY OF THE INVENTION

The present disclosure provides a governance-conditioned memory evolution architecture configured to establish authoritative memory states, determine signed delta-state relationships, generate associations, determine governance relationships, form governance-conditioned memory structures, determine admissibility, preserve continuity and lineage, support memory evolution, and establish future authoritative memory states.

In some embodiments, one or more authoritative memory states are established according to governance-conditioned admissibility relationships.

In some embodiments, one or more signed delta-state relationships are determined relative to one or more authoritative memory states. The signed delta-state relationships may comprise positive delta-state relationships, negative delta-state relationships, directional delta-state relationships, multi-baseline delta-state relationships, delta-to-delta relationships, or combinations thereof.

In some embodiments, one or more associations are generated according to one or more signed delta-state relationships. Governance relationships are determined according to the associations and the signed delta-state relationships.

In some embodiments, governance-conditioned memory structures are generated according to the governance relationships. Admissibility relationships determine whether participation within subsequent memory-evolution relationships is permitted.

In some embodiments, memory evolution occurs according to governance-conditioned participation relationships associated with authoritative memory states, signed delta-state relationships, associations, governance relationships, admissibility relationships, memory structures, continuity relationships, lineage relationships, or combinations thereof.

In some embodiments, future authoritative memory states are established according to governance-conditioned memory evolution relationships.

The disclosed architecture preserves memory as a governance-conditioned constitutional operational reality rather than merely a storage structure, thereby enabling authoritative memory formation, governance-conditioned memory evolution, continuity preservation, lineage preservation, admissibility determination, and future authoritative memory-state formation.

### BRIEF DESCRIPTION OF DRAWINGS

FIG. 1—Authoritative Memory-State and Signed Delta Constitution Architecture

FIG. 2—Multi-Baseline Signed Delta Constitution Architecture

FIG. 3—Delta-State Association and Governance Architecture

FIG. 4—Delta-to-Delta Governance Architecture

FIG. 5—Causal Association and Memory-Formation Architecture

FIG. 6—Directional Memory-Evolution Architecture

FIG. 7—Admissibility-Governed Memory Evolution Architecture

FIG. 8—Future Authoritative Memory-State Formation Architecture

### DETAILED DESCRIPTION OF THE INVENTION

The figures presented in this Section are provided solely as illustrative examples of governance-conditioned memory-state formation, signed delta-state determination, association formation, memory evolution, continuity preservation, reconstruction continuity preservation, and future authoritative memory-state formation relationships. The illustrated structures, arrangements, associations, governance relationships, admissibility relationships, continuity relationships, and memory-evolution relationships are exemplary and non-limiting.

The disclosed subject matter is not limited to any particular memory representation, state representation, delta representation, governance representation, admissibility representation, continuity representation, reconstruction representation, computational architecture, mathematical formulation, software implementation, hardware implementation, storage implementation, communication implementation, artificial-intelligence implementation, machine-learning implementation, or operational environment.

Authoritative memory states, signed delta-state relationships, positive delta-state relationships, negative delta-state relationships, directional delta-state relationships, multi-baseline delta-state relationships, delta-to-delta relationships, association relationships, memory-formation relationships, admissibility relationships, governance relationships, memory-evolution relationships, lineage continuity relationships, reconstruction continuity relationships, and future authoritative memory-state relationships may be established, determined, generated, validated, preserved, reconstructed, inherited, evolved, reused, or otherwise constituted according to any suitable governance-conditioned implementation.

The signed delta-state relationships may include positive delta-state relationships, negative delta-state relationships, directional delta-state relationships, multi-baseline delta-state relationships, delta-to-delta relationships, or combinations thereof.

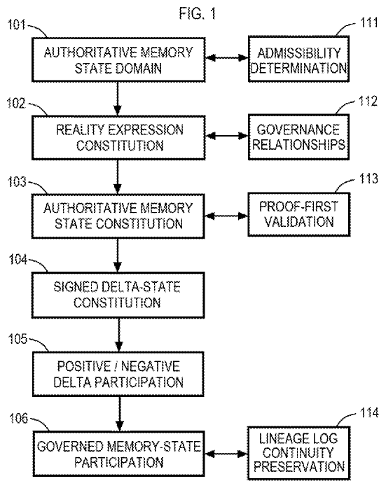

The architectures illustrated in FIGS. 1-8 collectively describe a unified governance-conditioned memory evolution architecture. The illustrated structures are intended to be interpreted collectively and cooperatively rather than as isolated, separable, optional, bypassable, or independently substitutable components.

Accordingly, no individual structure, relationship, governance determination, admissibility determination, memory state, signed delta-state relationship, memory structure, memory-evolution relationship, lineage continuity relationship, reconstruction continuity relationship, or future authoritative memory-state relationship should be interpreted as limiting the scope of the disclosed subject matter.

The disclosed subject matter expressly contemplates distributed implementations, federated implementations, virtualized implementations, inherited implementations, reconstructed implementations, structural equivalents, functional equivalents, governance equivalents, continuity-preserving equivalents, and future-state formation equivalents consistent with the claims.

Structures 101-106 collectively define an authoritative memory-state and signed delta-state constitution architecture configured to establish authoritative memory states and determine governance-conditioned signed delta-state relationships.

FIG. 1 illustrates a governance-conditioned authoritative memory-state and signed delta constitution architecture. Structure 101 defines an authoritative memory-state domain configured to establish governance-conditioned authoritative memory states. Structure 102 defines reality expression constitution structures configured to receive reality expressions, fact expressions, operational expressions, memory expressions, state expressions, or combinations thereof. Structure 103 defines authoritative memory-state constitution structures configured to establish authoritative memory states according to governance-conditioned admissibility relationships. Structure 104 defines signed delta-state constitution structures configured to determine one or more signed delta-state relationships relative to one or more authoritative memory states. Structure 105 defines positive delta-state participation and negative delta-state participation structures configured to determine directional delta-state relationships associated with the signed delta-state relationships. Structure 106 defines governed memory-state participation structures configured to permit governance-conditioned participation of authoritative memory states and signed delta-state relationships within subsequent memory-formation relationships. Structure 111 defines admissibility structures configured to determine admissibility relationships associated with the authoritative memory states and signed delta-state relationships. Structure 112 defines governance structures configured to determine governance relationships associated with the authoritative memory states and signed delta-state relationships. Structure 113 defines proof-first validation structures configured to validate governance-conditioned participation relationships. Structure 114 defines lineage log structures configured to preserve lineage continuity relationships associated with the authoritative memory states and signed delta-state relationships.

Structures 201-206 collectively define a multi-baseline signed delta-state architecture configured to support determination of signed delta-state relationships relative to multiple authoritative memory states.

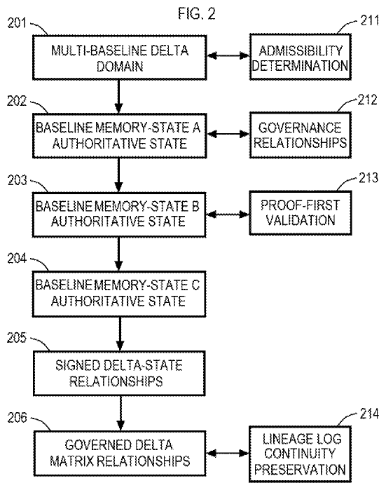

FIG. 2 illustrates a governance-conditioned multi-baseline signed delta constitution architecture. Structure 201 defines a multi-baseline delta domain configured to support multiple authoritative memory states. Structure 202 defines baseline memory-state A structures configured to establish a first authoritative memory state. Structure 203 defines baseline memory-state B structures configured to establish a second authoritative memory state. Structure 204 defines baseline memory-state C structures configured to establish a third authoritative memory state. Structure 205 defines signed delta relationship structures configured to determine one or more signed delta-state relationships relative to one or more authoritative memory states. Structure 206 defines governed delta matrix structures configured to preserve governance-conditioned relationships among multiple signed delta-state relationships. Structure 211 defines admissibility structures configured to determine admissibility relationships associated with the multiple authoritative memory states. Structure 212 defines governance structures configured to determine governance relationships associated with the governed delta matrix. Structure 213 defines proof-first validation structures configured to validate governance-conditioned delta participation relationships. Structure 214 defines lineage log structures configured to preserve continuity relationships associated with the multiple authoritative memory states and the governed delta matrix.

Structures 301-306 collectively define association-formation, governance, memory-formation, and memory participation architectures configured to generate associations and memory structures according to signed delta-state relationships and governance relationships.

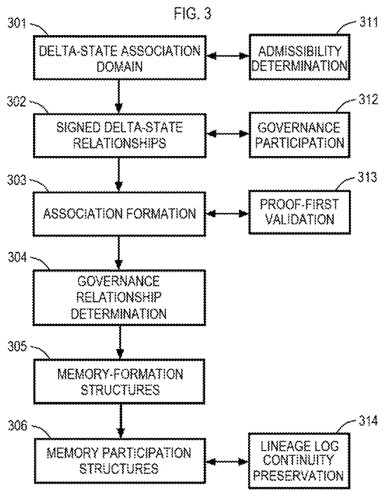

FIG. 3 illustrates a governance-conditioned delta-state association and governance architecture. Structure 301 defines a delta-state association domain configured to support governance-conditioned association formation. Structure 302 defines signed delta-state relationship structures configured to determine one or more signed delta-state relationships. Structure 303 defines association-formation structures configured to generate one or more associations according to the one or more signed delta-state relationships. Structure 304 defines governance relationship structures configured to determine governance relationships according to the generated associations and the signed delta-state relationships. Structure 305 defines memory-formation structures configured to generate one or more memory structures according to the governance relationships. Structure 306 defines memory participation structures configured to permit governance-conditioned participation of the memory structures within subsequent memory-evolution relationships. Structure 311 defines admissibility structures configured to determine admissibility relationships associated with the generated memory structures. Structure 312 defines governance structures configured to determine governance-conditioned participation relationships. Structure 313 defines proof-first validation structures configured to validate memory-formation relationships. Structure 314 defines lineage log structures configured to preserve lineage continuity relationships associated with the memory structures.

Structures 401-406 collectively define governance and delta-based admissibility architectures configured to determine governance relationships according to relationships among multiple signed delta-state relationships.

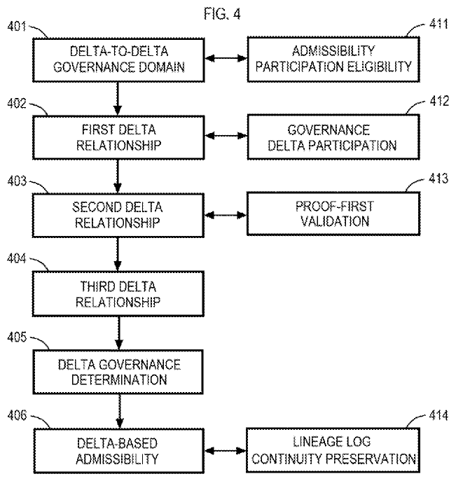

FIG. 4 illustrates a governance-conditioned delta-to-delta governance architecture. Structure 401 defines a delta-to-delta governance domain configured to support governance determinations according to relationships among multiple signed delta-state relationships. Structure 402 defines first delta relationship structures. Structure 403 defines second delta relationship structures. Structure 404 defines third delta relationship structures. Structure 405 defines delta-governance structures configured to determine governance relationships according to relationships among the multiple signed delta-state relationships. Structure 406 defines delta-based admissibility structures configured to determine admissibility according to governance relationships associated with the multiple signed delta-state relationships. Structure 411 defines admissibility structures configured to determine governance-conditioned participation eligibility. Structure 412 defines governance structures configured to determine governance-conditioned delta participation relationships. Structure 413 defines proof-first validation structures configured to validate delta-to-delta governance relationships. Structure 414 defines lineage log structures configured to preserve continuity relationships associated with the multiple signed delta-state relationships.

Structures 501-506 collectively define a causal association architecture and a memory-formation architecture configured to associate signed delta-state relationships with causes, reasons, and governance-conditioned memory structures.

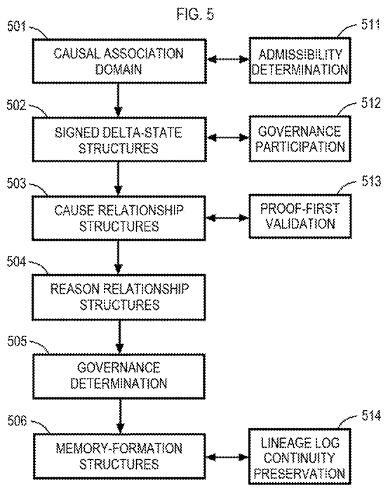

FIG. 5 illustrates a governance-conditioned causal association and memory-formation architecture. Structure 501 defines a causal association domain configured to associate signed delta-state relationships with one or more cause relationships. Structure 502 defines signed delta-state structures configured to determine one or more signed delta-state relationships. Structure 503 defines cause relationship structures configured to associate the signed delta-state relationships with one or more cause relationships. Structure 504 defines reason relationship structures configured to associate one or more reasons with the signed delta-state relationships. Structure 505 defines governance determination structures configured to determine governance relationships according to the signed delta-state relationships and the associated cause relationships. Structure 506 defines memory-formation structures configured to generate one or more memory structures according to the governance relationships. Structure 511 defines admissibility structures configured to determine admissibility relationships associated with the generated memory structures. Structure 512 defines governance structures configured to determine governance-conditioned participation relationships. Structure 513 defines proof-first validation structures configured to validate causal participation relationships. Structure 514 defines lineage log structures configured to preserve continuity relationships associated with the cause relationships and the generated memory structures.

Structures 601-606 collectively define a memory-evolution architecture configured to determine memory evolution according to directional characteristics associated with signed delta-state relationships.

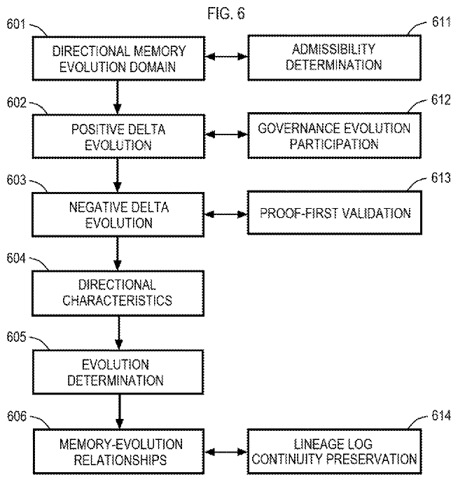

FIG. 6 illustrates a governance-conditioned directional memory-evolution architecture. Structure 601 defines a directional memory-evolution domain configured to determine memory evolution according to directional characteristics associated with signed delta-state relationships. Structure 602 defines positive delta-evolution structures configured to support expansion-oriented memory evolution. Structure 603 defines negative delta-evolution structures configured to support contraction-oriented memory evolution. Structure 604 defines directional characteristic structures configured to determine directional characteristics associated with one or more signed delta-state relationships. Structure 605 defines evolution-determination structures configured to determine memory evolution according to the directional characteristics. Structure 606 defines memory-evolution structures configured to establish governance-conditioned memory-evolution relationships. Structure 611 defines admissibility structures configured to determine admissibility relationships associated with memory evolution. Structure 612 defines governance structures configured to determine governance-conditioned memory-evolution participation relationships. Structure 613 defines proof-first validation structures configured to validate memory-evolution relationships. Structure 614 defines lineage log structures configured to preserve continuity relationships associated with memory evolution.

Structures 701-706 collectively define admissibility and governance-conditioned memory-evolution architectures configured to determine admissible participation within governance-conditioned memory-evolution relationships.

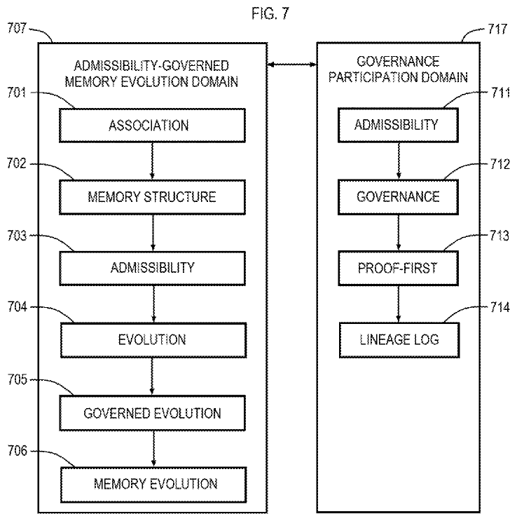

FIG. 7 illustrates a governance-conditioned admissibility-governed memory evolution architecture. Structure 707 defines an admissibility-governed memory evolution domain configured to contain association structures, memory structure constitution structures, admissibility determination structures, evolution participation structures, and governance-conditioned memory-evolution structures associated with governance-conditioned memory evolution. Structure 701 defines an admissibility-governed memory evolution domain configured to support governance-conditioned memory evolution. Structure 702 defines association structures configured to provide association-derived memory-formation inputs. Structure 703 defines memory structure constitution structures configured to establish one or more memory structures. Structure 704 defines admissibility determination structures configured to determine admissibility according to the memory structures and signed delta-state relationships. Structure 705 defines evolution participation structures configured to permit admissible participation within memory-evolution relationships. Structure 706 defines governance-conditioned memory-evolution structures configured to determine memory evolution according to admissibility determinations. Structure 711 defines admissibility structures configured to preserve governance-conditioned participation eligibility. Structure 712 defines governance structures configured to determine governance-conditioned memory-evolution relationships. Structure 713 defines proof-first validation structures configured to validate admissibility-governed participation relationships. Structure 714 defines lineage log structures configured to preserve continuity relationships associated with memory evolution. Structure 717 defines a governance domain configured to contain admissibility structures, governance structures, proof-first validation structures, and lineage log structures associated with governance-conditioned memory-evolution relationships.

Structures 801-806 collectively define a future authoritative memory-state formation architecture configured to establish subsequent authoritative memory states according to memory evolution, governance-conditioned participation relationships, lineage continuity relationships, and reconstruction continuity relationships.

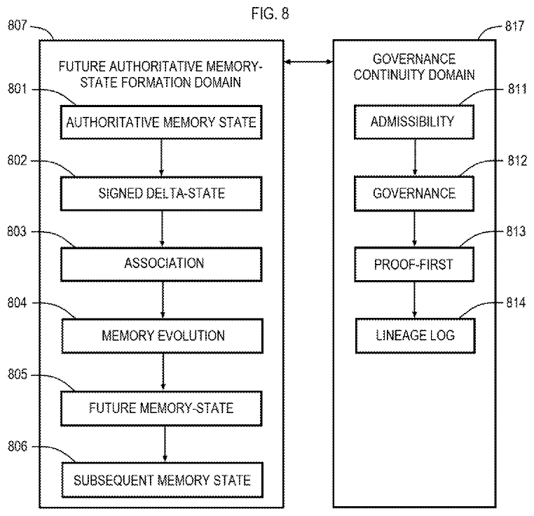

FIG. 8 illustrates a governance-conditioned future authoritative memory-state formation architecture. Structure 807 defines a future authoritative memory-state formation domain configured to contain authoritative memory-state structures, signed delta-state relationship structures, association-formation structures, memory-evolution structures, and future authoritative memory-state structures associated with future authoritative memory-state formation. Structure 801 defines a future authoritative memory-state formation domain configured to establish subsequent authoritative memory states. Structure 802 defines authoritative memory-state structures configured to establish one or more authoritative memory states. Structure 803 defines signed delta-state relationship structures configured to determine one or more signed delta-state relationships associated with the authoritative memory states. Structure 804 defines association-formation structures configured to generate one or more associations according to the signed delta-state relationships. Structure 805 defines memory-evolution structures configured to determine memory evolution according to governance-conditioned memory structures and signed delta-state relationships. Structure 806 defines future authoritative memory-state structures configured to establish a subsequent authoritative memory state according to the memory evolution. Structure 811 defines admissibility structures configured to determine admissibility relationships associated with future authoritative memory-state formation. Structure 812 defines governance structures configured to determine governance-conditioned future-state formation relationships. Structure 813 defines proof-first validation structures configured to validate future authoritative memory-state formation relationships. Structure 814 defines lineage log structures configured to preserve lineage continuity relationships and reconstruction continuity relationships associated with the authoritative memory states and the subsequent authoritative memory state. Structure 817 defines a governance domain configured to contain admissibility structures, governance structures, proof-first validation structures, and lineage log structures associated with future authoritative memory-state formation, lineage continuity preservation, and reconstruction continuity preservation.

The following description defines governance-conditioned authoritative memory states, signed delta-state relationships, association formation relationships, governance relationships, memory-formation relationships, admissibility relationships, memory-evolution relationships, continuity relationships, lineage relationships, and future authoritative memory-state formation relationships operating together as a unified governance-conditioned memory evolution architecture.

The disclosed architecture defines memory as a governance-conditioned constitutional operational reality rather than merely a storage structure. Authoritative memory states, signed delta-state relationships, association relationships, governance relationships, memory structures, admissibility relationships, continuity relationships, lineage relationships, and memory-evolution relationships operate together as inseparable constitutional components.

The disclosed architecture does not define memory according to storage alone. The disclosed architecture does not define memory according to language alone. The disclosed architecture does not define memory according to computation alone. Rather, memory is established through governance-conditioned memory-state formation relationships capable of participating in subsequent operational realities.

In some embodiments, one or more authoritative memory states are established according to governance-conditioned admissibility relationships.

Authoritative memory states may be established according to reality expressions, fact expressions, operational expressions, memory expressions, state expressions, event expressions, governance expressions, sensor expressions, environmental expressions, or combinations thereof.

An authoritative memory state constitutes a governance-conditioned memory state admitted for participation within subsequent memory-formation relationships, memory-evolution relationships, continuity relationships, lineage relationships, governance relationships, or combinations thereof.

Accordingly, authoritative memory states differ from transient values, temporary computations, generated outputs, temporary observations, isolated measurements, or combinations thereof.

Authoritative memory states preserve governance-conditioned constitutional continuity capable of participating in subsequent memory evolution.

In some embodiments, authoritative memory states participate as constitutional reference states.

One or more authoritative memory states may participate within association formation relationships.

One or more authoritative memory states may participate within governance relationships.

One or more authoritative memory states may participate within admissibility relationships.

One or more authoritative memory states may participate within continuity relationships.

One or more authoritative memory states may participate within lineage relationships.

One or more authoritative memory states may participate within memory-evolution relationships.

One or more authoritative memory states may participate within future authoritative memory-state formation relationships.

Accordingly, authoritative memory states may continue participating after establishment and are not limited to static storage relationships.

In some embodiments, one or more signed delta-state relationships are determined relative to one or more authoritative memory states.

A signed delta-state relationship may represent a governance-conditioned relationship between an authoritative memory state and a subsequent participation state.

Signed delta-state relationships may comprise:
positive delta-state relationships;
negative delta-state relationships;
directional delta-state relationships;
multi-baseline delta-state relationships;
delta-to-delta relationships;
or combinations thereof.

The architecture therefore permits memory evolution through governance-conditioned signed delta-state participation rather than through immediate state replacement.

Subsequent states are not required to replace previously established authoritative memory states.

Instead, signed delta-state relationships preserve constitutional continuity while enabling memory evolution.

In some embodiments, positive delta-state relationships represent governance-conditioned directional relationships associated with expansion, accumulation, increase, strengthening, enrichment, extension, growth, or combinations thereof.

A positive delta-state relationship may participate within governance determinations.

A positive delta-state relationship may participate within memory-formation relationships.

A positive delta-state relationship may participate within admissibility relationships.

A positive delta-state relationship may participate within memory-evolution relationships.

A positive delta-state relationship may participate within future authoritative memory-state formation relationships.

Accordingly, positive delta-state relationships constitute governance-conditioned memory-evolution participation relationships rather than merely mathematical differences.

In some embodiments, negative delta-state relationships represent governance-conditioned directional relationships associated with contraction, reduction, degradation, weakening, removal, decline, limitation, or combinations thereof.

A negative delta-state relationship may participate within governance determinations.

A negative delta-state relationship may participate within memory-formation relationships.

A negative delta-state relationship may participate within admissibility relationships.

A negative delta-state relationship may participate within memory-evolution relationships.

A negative delta-state relationship may participate within future authoritative memory-state formation relationships.

Accordingly, negative delta-state relationships constitute governance-conditioned memory-evolution participation relationships rather than merely mathematical differences.

In some embodiments, signed delta-state relationships comprise directional characteristics.

Directional characteristics may indicate:
expansion-oriented participation;
contraction-oriented participation;
stabilization-oriented participation;
correction-oriented participation;
oscillation-oriented participation;
adaptation-oriented participation;
or combinations thereof.

Memory evolution may therefore be determined according to directional characteristics associated with signed delta-state relationships.

Accordingly, memory evolution is not limited to state existence alone and may be determined according to governance-conditioned directional participation relationships.

In some embodiments, multiple authoritative memory states coexist as governance-conditioned reference states.

A first authoritative memory state may exist.

A second authoritative memory state may exist.

A third authoritative memory state may exist.

Additional authoritative memory states may exist.

Signed delta-state relationships may be determined relative to any one of the authoritative memory states or relative to multiple authoritative memory states.

Accordingly, memory evolution is not restricted to a single immediately preceding state.

The architecture permits governance-conditioned memory evolution according to relationships among multiple authoritative memory states.

In some embodiments, signed delta-state relationships may be associated with multiple authoritative memory states.

A first signed delta-state relationship may be determined relative to a first authoritative memory state.

A second signed delta-state relationship may be determined relative to a second authoritative memory state.

A third signed delta-state relationship may be determined relative to a third authoritative memory state.

Governance relationships may be determined according to relationships among the multiple signed delta-state relationships.

Accordingly, memory evolution may be determined according to governance-conditioned multi-baseline participation relationships while preserving continuity associated with multiple authoritative memory states.

In some embodiments, governance determinations are performed according to relationships among multiple signed delta-state relationships.

A first signed delta-state relationship may participate in governance determination.

A second signed delta-state relationship may participate in governance determination.

A third signed delta-state relationship may participate in governance determination.

Governance relationships may therefore be determined according to relationships among multiple signed delta-state relationships rather than solely according to state values.

Accordingly, signed delta-state relationships participate as governance-conditioned constitutional objects rather than merely representing state differences.

In some embodiments, admissibility relationships are determined according to one or more signed delta-state relationships.

Admissibility relationships may be determined according to:
positive delta-state relationships;
negative delta-state relationships;
directional delta-state relationships;
multi-baseline delta-state relationships;
delta-to-delta relationships;
or combinations thereof.

The resulting admissibility relationships determine whether participation within subsequent memory-formation relationships is permitted.

Accordingly, signed delta-state relationships may directly participate in governance-conditioned admissibility determination relationships.

In some embodiments, one or more associations are generated according to one or more signed delta-state relationships.

Association formation may occur according to:
context relationships;
event relationships;
temporal relationships;
operational relationships;
environmental relationships;
governance relationships;
lineage relationships;
state relationships;
or combinations thereof.

A signed delta-state relationship may participate in generation of one or more associations.

Multiple signed delta-state relationships may participate in generation of one or more associations.

Multiple authoritative memory states may participate in generation of one or more associations.

Accordingly, association formation is not limited to direct state comparison relationships.

Instead, association formation preserves governance-conditioned constitutional relationships among participating memory structures.

In some embodiments, associations constitute memory-formation inputs.

Associations may preserve relationships among:
authoritative memory states;
signed delta-state relationships;
events;
contexts;
participants;
conditions;
sources;
operational realities;
or combinations thereof.

The resulting associations participate in governance-conditioned memory-state formation relationships.

Accordingly, memory may participate as interconnected constitutional memory structures rather than isolated storage elements.

In some embodiments, memory states comprise context relationships.

Context relationships may comprise:
time relationships;
location relationships;
participant relationships;
object relationships;
source relationships;
environmental relationships;
operational relationships;
governance relationships;
continuity relationships;
or combinations thereof.

Context relationships may participate in association formation.

Context relationships may participate in governance relationships.

Context relationships may participate in admissibility determination.

Context relationships may participate in memory formation.

Accordingly, memory preserves contextual meaning beyond preservation of underlying values.

In some embodiments, memory states are associated with event relationships.

Event relationships may comprise:
measurements;
observations;
actions;
interactions;
operational occurrences;
environmental occurrences;
governance occurrences;
state-transition occurrences;
or combinations thereof.

Event relationships may participate in association formation.

Event relationships may participate in governance relationships.

Event relationships may participate in memory formation.

Event relationships may participate in memory evolution.

Accordingly, the architecture preserves event participation relationships rather than merely storing isolated values.

In some embodiments, governance relationships are determined according to:
authoritative memory states;
signed delta-state relationships;
association relationships;
context relationships;
event relationships;
continuity relationships;
lineage relationships;
or combinations thereof.

Governance relationships determine constitutional participation eligibility associated with memory formation and memory evolution.

Accordingly, governance relationships constitute memory participation determination structures rather than passive storage relationships.

In some embodiments, memory structures are generated according to governance relationships.

Memory formation may occur according to:
admitted associations;
admitted signed delta-state relationships;
admitted contexts;
admitted events;
admitted governance relationships;
or combinations thereof.

The resulting memory structures constitute governance-conditioned memory structures capable of participating within subsequent operational realities.

Accordingly, memory formation differs from storage of values alone.

Raw data does not constitute memory.

Memory is established through governance-conditioned memory-state formation relationships.

In some embodiments, raw data alone does not constitute memory.

Measurements alone do not constitute memory.

Signals alone do not constitute memory.

Values alone do not constitute memory.

Generated outputs alone do not constitute memory.

Memory is established only after participation in governance-conditioned memory-state formation relationships.

Accordingly, memory may require:
admissibility relationships;
association relationships;
context relationships;
event relationships;
continuity relationships;
lineage relationships;
governance relationships;
or combinations thereof.

The architecture therefore distinguishes memory from conventional storage systems.

In some embodiments, admissibility relationships are determined according to:
authoritative memory states;
signed delta-state relationships;
associations;
contexts;
events;
memory structures;
governance relationships;
or combinations thereof.

Admissibility relationships determine whether participation within subsequent memory-evolution relationships is permitted.

Accordingly, admissibility relationships function as constitutional participation determination structures.

In some embodiments, reasoning outputs do not automatically constitute authoritative memory states.

Reasoning outputs may participate as:
participation candidates;
memory candidates;
state candidates;
governance candidates;
or combinations thereof.

Reasoning outputs may therefore require admissibility determination prior to participation in authoritative memory-state formation relationships.

Accordingly, generated outputs remain distinct from authoritative memory states until governance-conditioned admission occurs.

In some embodiments, reasoning participation occurs according to one or more authoritative memory states.

Authoritative memory states participate as constitutional reference structures.

Reasoning outputs do not define authoritative memory states.

Reasoning outputs may instead participate as candidate structures until admitted through governance-conditioned admissibility relationships.

Accordingly, the architecture preserves a distinction between generated outputs and authoritative memory states.

In some embodiments, memory evolution is determined according to:
admissibility relationships;
governance relationships;
signed delta-state relationships;
association relationships;
memory structures;
or combinations thereof.

Positive delta-state relationships may participate in expansion-oriented memory evolution.

Negative delta-state relationships may participate in contraction-oriented memory evolution.

Directional delta-state relationships may participate in stabilization-oriented memory evolution.

Accordingly, memory evolution occurs according to governance-conditioned signed delta-state participation rather than isolated state replacement.

In some embodiments, previously established authoritative memory states may participate in subsequent memory formation relationships before initiation of additional computation.

Memory inheritance may therefore occur before repeated computational reconstruction.

Previously established authoritative memory states may participate in:
association formation;
governance determination;
admissibility determination;
memory formation;
memory evolution;
future authoritative memory-state formation;
or combinations thereof.

Accordingly, continuity preservation may reduce repeated computation through memory inheritance.

In some embodiments, lineage relationships preserve continuity associated with authoritative memory states.

Lineage relationships may preserve:
state relationships;
event relationships;
association relationships;
governance relationships;
memory relationships;
continuity relationships;
or combinations thereof.

The resulting lineage relationships permit reconstruction continuity and memory-evolution continuity.

Accordingly, continuity is preserved even when memory evolution occurs.

In some embodiments, subsequent authoritative memory states are established according to memory evolution.

Authoritative memory states may participate in future authoritative memory-state formation.

Signed delta-state relationships may participate in future authoritative memory-state formation.

Association relationships may participate in future authoritative memory-state formation.

Governance relationships may participate in future authoritative memory-state formation.

Admissibility relationships may participate in future authoritative memory-state formation.

Memory structures may participate in future authoritative memory-state formation.

Continuity relationships and lineage relationships may participate in future authoritative memory-state formation.

Accordingly, future authoritative memory states emerge according to governance-conditioned memory evolution rather than solely according to current-state existence.

In some embodiments, a future authoritative memory state becomes a subsequent authoritative memory state.

The subsequent authoritative memory state may thereafter participate in additional signed delta-state determination relationships.

The subsequent authoritative memory state may participate in additional association formation relationships.

The subsequent authoritative memory state may participate in additional governance relationships.

The subsequent authoritative memory state may participate in additional memory-evolution relationships.

The architecture therefore supports continuous governance-conditioned memory evolution while preserving continuity associated with prior authoritative memory states.

The disclosed architecture operates according to a memory-first constitutional model.

The protected center of the invention remains directed to authoritative memory states, signed delta-state relationships, association formation, governance-conditioned memory formation, admissibility determination, memory evolution, continuity preservation, lineage preservation, and future authoritative memory-state formation.

The principles below further define constitutional characteristics associated with memory participation and distinguish governance-conditioned memory architectures from conventional data-processing architectures, storage architectures, database architectures, vector-storage architectures, retrieval architectures, language-generation architectures, and computation-centric architectures.

In some embodiments, memory formation occurs prior to language formation.

Memory participation may occur prior to language participation.

Memory structures may be established before generation of natural-language descriptions associated with those memory structures.

Accordingly, establishment of authoritative memory states does not require natural-language representation.

Authoritative memory states may therefore exist independently of language expressions.

Subsequent language expressions may be generated after memory formation.

The architecture therefore distinguishes memory formation from language formation.

In some embodiments, memory participation occurs prior to language participation.

Governance-conditioned memory structures may participate within operational realities before generation of corresponding language expressions.

Memory participation may therefore occur through:
state participation;
event participation;
operational participation;
sensor participation;
governance participation;
continuity participation;
or combinations thereof.

Accordingly, language participation is not required for memory participation.

In some embodiments, control memories may be established prior to language memories.

Operational memories may be established prior to semantic memories.

State memories may be established prior to linguistic representations.

Governance-conditioned operational memory states may therefore participate within operational realities before generation of natural-language descriptions associated with those operational memory states.

Accordingly, the architecture permits memory participation within autonomous systems, robotic systems, industrial systems, infrastructure systems, environmental systems, artificial-intelligence systems, communication systems, and other systems without requiring language generation.

In some embodiments, operational memories may be established according to operational participation relationships.

Semantic interpretations may be established after operational memory formation.

Operational memory states may therefore preserve operational realities before generation of semantic descriptions associated with those realities.

Accordingly, semantic memory may derive from operational memory participation rather than defining operational memory participation.

In some embodiments, raw data alone does not constitute memory.

Measurements alone do not constitute memory.

Signals alone do not constitute memory.

Numerical values alone do not constitute memory.

Stored values alone do not constitute memory.

Generated outputs alone do not constitute memory.

Data becomes memory only after participation in governance-conditioned memory-state formation relationships.

Accordingly, memory is not defined according to storage alone.

Memory is established according to governance-conditioned constitutional participation relationships.

In some embodiments, memory formation requires participation within governance-conditioned constitutional relationships.

Such constitutional relationships may comprise:
admissibility relationships;
association relationships;
context relationships;
event relationships;
continuity relationships;
lineage relationships;
governance relationships;
or combinations thereof.

Accordingly, memory formation differs from conventional storage relationships.

In some embodiments, memory states comprise context relationships.

Context relationships may comprise:
time relationships;
location relationships;
participant relationships;
object relationships;
source relationships;
environmental relationships;
operational relationships;
governance relationships;
continuity relationships;
or combinations thereof.

Accordingly, memory preserves contextual meaning associated with participation realities.

Memory therefore extends beyond preservation of isolated values.

In some embodiments, context relationships participate in memory formation.

Context relationships may participate in:
association formation;
governance determination;
admissibility determination;
memory formation;
memory evolution;
future authoritative memory-state formation;
or combinations thereof.

Accordingly, context constitutes an active constitutional component of memory formation.

In some embodiments, memory states are associated with event relationships.

Event relationships may comprise:
measurements;
observations;
actions;
interactions;
operational occurrences;
environmental occurrences;
governance occurrences;
state-transition occurrences;
or combinations thereof.

Accordingly, memory may preserve event participation relationships rather than isolated numerical values.

In some embodiments, event relationships participate in memory evolution.

Event relationships may participate in:
association formation;
governance determination;
admissibility determination;
memory formation;
continuity preservation;
memory evolution;
future authoritative memory-state formation;
or combinations thereof.

Accordingly, memory evolution may occur according to event participation relationships.

In some embodiments, memory formation comprises association formation relationships.

Associations may be formed according to:
context relationships;
event relationships;
temporal relationships;
state relationships;
operational relationships;
governance relationships;
continuity relationships;
lineage relationships;
or combinations thereof.

Accordingly, memory may participate as interconnected constitutional memory structures rather than isolated storage elements.

In some embodiments, associations constitute memory-formation inputs.

The resulting associations participate in governance-conditioned memory-state formation relationships.

Accordingly, memory formation may occur according to admitted associations rather than isolated values.

In some embodiments, reasoning participation occurs according to one or more authoritative memory states.

Authoritative memory states participate as governance-conditioned constitutional reference structures.

Reasoning outputs do not automatically constitute authoritative memory states.

Reasoning outputs may instead participate as candidate structures.

Accordingly, authoritative memory states precede reasoning participation.

In some embodiments, reasoning outputs participate as:
memory candidates;
state candidates;
participation candidates;
governance candidates;
or combinations thereof.

Reasoning outputs require governance-conditioned admissibility determination before participation within authoritative memory-state formation relationships.

Accordingly, generated outputs remain distinct from authoritative memory states until admitted.

In some embodiments, previously established authoritative memory states may be reused before initiation of additional computation.

Memory inheritance may therefore occur before repeated computational reconstruction.

Previously established authoritative memory states may participate in subsequent memory formation relationships without requiring recreation through computation.

Accordingly, memory reuse may reduce computational requirements while preserving continuity.

In some embodiments, memory inheritance preserves continuity associated with previously established authoritative memory states.

Continuity relationships may preserve:
association relationships;
event relationships;
governance relationships;
memory relationships;
state relationships;
lineage relationships;
or combinations thereof.

Accordingly, memory inheritance supports continuity-preserving memory evolution.

In some embodiments, memory evolution occurs through signed delta-state relationships relative to one or more authoritative memory states.

An authoritative memory state participates as a governance-conditioned reference state.

One or more positive delta-state relationships may be determined.

One or more negative delta-state relationships may be determined.

One or more directional delta-state relationships may be determined.

One or more multi-baseline delta-state relationships may be determined.

Accordingly, memory evolution may be determined according to governance-conditioned signed delta-state participation rather than isolated state replacement.

In some embodiments, natural-language expressions constitute one category of memory-expression forms.

Memory expressions may additionally comprise:
sensor expressions;
operational expressions;
image expressions;
signal expressions;
state expressions;
event expressions;
governance expressions;
reality expressions;
fact expressions;
or combinations thereof.

Accordingly, language does not define memory.

Language constitutes one possible expression mechanism through which memory states may be represented.

In some embodiments, a single authoritative memory state may be represented through multiple memory-expression forms.

The same authoritative memory state may therefore participate through language expressions, sensor expressions, operational expressions, signal expressions, image expressions, governance expressions, or combinations thereof.

Accordingly, memory remains independent of any single expression mechanism.

The disclosed architecture operates according to a memory-first constitutional model.

Memory formation precedes language participation.

Memory participation precedes reasoning participation.

Authoritative memory states precede delta-state evolution.

Governance-conditioned memory formation precedes memory evolution.

Raw data does not constitute memory.

Memory is established through governance-conditioned memory-state formation relationships.

Memory may comprise context relationships, event relationships, association relationships, continuity relationships, lineage relationships, governance relationships, signed delta-state relationships, or combinations thereof.

Accordingly, the disclosed architecture preserves memory as a constitutional operational reality rather than merely a storage structure, thereby enabling authoritative memory formation, governance-conditioned memory evolution, continuity preservation, lineage preservation, and memory-conditioned participation within subsequent operational realities.

### DETAILED EXAMPLES

The following examples are provided solely to illustrate governance-conditioned authoritative memory-state formation, signed delta-state participation, association formation, governance determination, admissibility determination, memory formation, memory evolution, continuity preservation, lineage preservation, and future authoritative memory-state formation.

The examples are non-limiting.

The disclosed architecture is not restricted to the particular implementations described below.

### Detailed Example 1—Greenhouse Temperature Memory Evolution

An authoritative memory state may indicate that a greenhouse temperature was twenty-five degrees Celsius at a first time.

A subsequent temperature of twenty-eight degrees Celsius may participate as a positive signed delta-state relationship relative to the authoritative memory state.

Associations may identify:
solar radiation conditions;
time-of-day conditions;
seasonal conditions;
environmental conditions;
or combinations thereof.

Governance relationships determine admissibility.

An admissible memory structure is generated.

Memory evolution establishes a future authoritative memory state representing governance-conditioned environmental evolution rather than merely storing numerical values.

### Detailed Example 2—Greenhouse Crop Development Memory

An authoritative memory state may indicate a crop-development condition during a first growth stage.

Subsequent observations participate as signed delta-state relationships.

Associations identify lighting conditions, environmental conditions, irrigation conditions, nutrient conditions, and developmental conditions.

Governance relationships determine admissibility.

Memory evolution preserves crop-development continuity.

Future authoritative memory states preserve developmental lineage associated with the crop.

### Detailed Example 3—Large Language Model Memory Admission

A large language model generates a recommendation.

The recommendation does not automatically constitute an authoritative memory state.

The recommendation participates as a candidate structure.

Governance relationships determine admissibility.

If admitted, the recommendation participates in memory formation.

If not admitted, the recommendation remains a non-authoritative candidate.

Accordingly, generated outputs remain distinct from authoritative memory states.

### Detailed Example 4—Large Language Model Knowledge Evolution

An authoritative memory state may indicate an admitted factual relationship.

A large language model generates additional reasoning.

The generated reasoning participates as a candidate relationship.

Associations identify supporting evidence, contextual evidence, historical evidence, governance evidence, or combinations thereof.

Governance relationships determine admissibility.

Memory evolution occurs only after governance-conditioned admission.

### Detailed Example 5—Autonomous Vehicle Control Memory

An autonomous vehicle detects an obstacle.

An operational memory state is established.

The operational memory state may participate before generation of any natural-language description.

Control memory therefore precedes language memory.

Subsequent language descriptions may be generated after memory formation.

Accordingly, memory formation occurs independently of language formation.

### Detailed Example 6—Autonomous Vehicle Memory Evolution

A first authoritative memory state indicates an unobstructed roadway.

A subsequent sensor observation participates as a signed delta-state relationship.

Associations identify environmental conditions, vehicle conditions, roadway conditions, and continuity relationships.

Governance relationships determine admissibility.

Memory evolution establishes a future authoritative memory state associated with roadway participation.

### Detailed Example 7—Industrial Robot Memory Evolution

An industrial robot establishes an authoritative memory state indicating normal operating torque.

A subsequent torque measurement participates as a negative signed delta-state relationship.

Associations identify tool conditions, environmental conditions, maintenance conditions, operational conditions, and continuity relationships.

Governance relationships determine admissibility.

Memory evolution preserves degradation continuity while establishing a future authoritative memory state.

### Detailed Example 8—Industrial Equipment Health Memory

An authoritative memory state indicates normal equipment vibration.

Subsequent vibration measurements participate as signed delta-state relationships.

Associations identify operational history, maintenance history, environmental conditions, and equipment conditions.

Governance-conditioned admissibility determines memory participation.

Memory evolution preserves equipment-health continuity rather than merely storing measurements.

### Detailed Example 9—Power-Grid Memory Evolution

An authoritative memory state indicates a normal operational condition of a power-grid segment.

Subsequent operational observations participate as signed delta-state relationships.

Associations identify load conditions, environmental conditions, infrastructure conditions, and continuity relationships.

Governance relationships determine admissibility.

Memory evolution preserves operational continuity associated with the power-grid segment.

### Detailed Example 10—Network Memory Evolution

An authoritative memory state indicates a previously admitted network condition.

Subsequent observations participate as signed delta-state relationships.

Associations identify communication conditions, infrastructure conditions, operational conditions, and governance conditions.

Memory evolution establishes a future authoritative memory state associated with network participation continuity.

### Detailed Example 11—Medical Observation Memory

An authoritative memory state indicates a baseline physiological condition.

Subsequent observations participate as signed delta-state relationships.

Associations preserve time relationships, location relationships, equipment relationships, personnel relationships, environmental relationships, and continuity relationships.

Governance relationships determine admissibility.

Memory evolution preserves continuity associated with the physiological condition.

### Detailed Example 12—Clinical Knowledge Evolution

An authoritative memory state indicates an admitted clinical observation.

Subsequent evidence participates as positive signed delta-state relationships or negative signed delta-state relationships.

Associations preserve supporting evidence, contradictory evidence, contextual evidence, and continuity relationships.

Governance relationships determine admissibility.

Future authoritative memory states evolve according to governance-conditioned memory evolution.

### Detailed Example 13—Engineering Knowledge Memory

An authoritative memory state indicates an accepted engineering principle.

Subsequent engineering observations participate as signed delta-state relationships.

Associations preserve supporting evidence, contradictory evidence, operational evidence, and lineage relationships.

Governance relationships determine admissibility.

Memory evolution preserves engineering continuity while permitting evolution of engineering knowledge structures.

### Detailed Example 14—Organizational Memory Evolution

An authoritative memory state indicates a previously admitted organizational policy.

Subsequent operational observations participate as signed delta-state relationships.

Associations preserve governance relationships, operational relationships, participant relationships, continuity relationships, and lineage relationships.

Governance relationships determine admissibility.

Memory evolution establishes a future authoritative memory state associated with organizational participation.

### Detailed Example 15—Multi-Baseline Memory Evolution

A first authoritative memory state may exist.

A second authoritative memory state may exist.

A third authoritative memory state may exist.

Signed delta-state relationships may be determined relative to one or more of the authoritative memory states.

Governance relationships may be determined according to relationships among the resulting signed delta-state relationships.

Memory evolution therefore occurs according to governance-conditioned multi-baseline participation relationships.

### Detailed Example 16—Delta-To-Delta Governance

A first signed delta-state relationship participates in governance determination.

A second signed delta-state relationship participates in governance determination.

A third signed delta-state relationship participates in governance determination.

Governance relationships are determined according to relationships among the signed delta-state relationships.

Admissibility relationships are determined according to the resulting governance relationships.

Memory formation and memory evolution occur according to the admissibility relationships.

### Detailed Example 17—Authoritative Memory Reuse

An authoritative memory state has previously been established.

A subsequent operational reality requires participation of the authoritative memory state.

The architecture reuses the authoritative memory state.

Memory inheritance occurs before repeated computational reconstruction.

Accordingly, continuity is preserved while reducing computational requirements.

### Detailed Example 18—Memory-Formation Without Language

An authoritative memory state is established according to operational participation relationships.

No natural-language description exists.

The authoritative memory state nevertheless participates within governance relationships, admissibility relationships, memory formation relationships, and memory evolution relationships.

Accordingly, memory formation occurs independently of language generation.

### Detailed Example 19—Sensor-Derived Memory Participation

A sensor generates measurements.

The measurements do not automatically constitute memory.

Associations are generated according to contextual relationships and event relationships.

Governance relationships determine admissibility.

Memory structures are formed according to admitted participation relationships.

Accordingly, raw measurements become memory only after governance-conditioned memory-state formation.

### Detailed Example 20—Future Authoritative Memory-State Formation

An authoritative memory state participates as a governance-conditioned reference state.

Signed delta-state relationships are determined.

Associations are generated.

Governance relationships determine admissibility.

Memory structures are generated.

Memory evolution occurs according to admitted participation relationships.

A future authoritative memory state is established.

The future authoritative memory state thereafter participates as a subsequent authoritative memory state within additional signed delta-state determination relationships, memory formation relationships, and memory evolution relationships.

The following embodiments illustrate engineering implementations of governance-conditioned authoritative memory states, signed delta-state relationships, association formation, governance determination, admissibility determination, memory formation, memory evolution, continuity preservation, lineage preservation, and future authoritative memory-state formation.

The embodiments are non-limiting and are provided solely to illustrate implementation possibilities associated with the disclosed architecture.

In some embodiments, incoming participation information is not immediately stored as memory.

Incoming information first participates as candidate information.

Candidate information may comprise:
sensor information;
operational information;
environmental information;
human-generated information;
artificial-intelligence-generated information;
communication information;
state information;
or combinations thereof.

The candidate information participates in association formation relationships.

Governance relationships determine admissibility.

Memory formation occurs after admissibility determination.

Accordingly, memory formation is distinguished from direct storage.

In some embodiments, memory formation occurs according to the following constitutional relationships:
candidate participation;
association formation;
governance determination;
admissibility determination;
memory formation;
memory evolution;
future authoritative memory-state formation.

Accordingly, storage operations do not automatically constitute memory formation.

Only admitted participation relationships become authoritative memory participation relationships.

In some embodiments, authoritative memory states participate within one or more memory-state registries.

The memory-state registries preserve:
authoritative memory-state identifiers;
continuity identifiers;
lineage identifiers;
governance identifiers;
association identifiers;
signed delta-state identifiers;
or combinations thereof.

The memory-state registries preserve constitutional participation relationships associated with authoritative memory states.

In some embodiments, signed delta-state relationships participate within one or more delta-state registries.

The delta-state registries preserve:
positive delta-state relationships;
negative delta-state relationships;
directional delta-state relationships;
multi-baseline delta-state relationships;
delta-to-delta relationships;
or combinations thereof.

The registries permit governance-conditioned memory evolution according to signed delta-state participation.

In some embodiments, associations participate within one or more association registries.

The association registries preserve:
context relationships;
event relationships;
state relationships;
continuity relationships;
governance relationships;
lineage relationships;
or combinations thereof.

The registries support memory formation according to governance-conditioned association participation.

In some embodiments, an admissibility engine determines whether participation relationships satisfy governance-conditioned admissibility requirements.

The admissibility engine may evaluate:
authoritative memory states;
signed delta-state relationships;
associations;
contexts;
events;
governance relationships;
or combinations thereof.

The admissibility engine determines whether participation within memory formation is permitted.

In some embodiments, a governance engine determines governance relationships associated with memory participation.

The governance engine may evaluate:
signed delta-state relationships;
association relationships;
memory structures;
continuity relationships;
lineage relationships;
or combinations thereof.

Governance determinations participate in admissibility determination and memory evolution.

In some embodiments, a memory-evolution engine determines memory evolution according to admitted participation relationships.

The memory-evolution engine may evaluate:
positive delta-state relationships;
negative delta-state relationships;
directional delta-state relationships;
multi-baseline delta-state relationships;
delta-to-delta relationships;
or combinations thereof.

Accordingly, memory evolution occurs according to governance-conditioned participation rather than isolated state replacement.

In some embodiments, a continuity engine preserves continuity associated with authoritative memory states.

The continuity engine preserves:
memory continuity;
association continuity;
event continuity;
governance continuity;
lineage continuity;
or combinations thereof.

Continuity preservation permits memory inheritance and future authoritative memory-state formation.

In some embodiments, a lineage engine preserves lineage relationships associated with memory participation.

Lineage relationships may preserve:
memory ancestry relationships;
delta-state ancestry relationships;
association ancestry relationships;
governance ancestry relationships;
continuity ancestry relationships;
or combinations thereof.

Lineage preservation permits reconstruction continuity and memory-evolution continuity.

In some embodiments, a future authoritative memory-state engine establishes subsequent authoritative memory states.

The future authoritative memory-state engine evaluates:
memory evolution;
admissibility relationships;
governance relationships;
continuity relationships;
lineage relationships;
or combinations thereof.

The resulting authoritative memory state becomes available for subsequent signed delta-state determination relationships.

In some embodiments, artificial-intelligence-generated outputs participate as candidate structures.

Artificial-intelligence-generated outputs do not automatically become authoritative memory states.

The outputs first participate within:
association formation;
governance determination;
admissibility determination;
memory formation;
or combinations thereof.

Only admitted participation relationships become authoritative memory states.

Accordingly, the architecture preserves a distinction between generated outputs and

authoritative memory states.

In some embodiments, authoritative memory states are distributed across multiple operational domains.

The operational domains may comprise:
communication domains;
software domains;
hardware domains;
robotic domains;
industrial domains;
environmental domains;
artificial-intelligence domains;
human domains;
or combinations thereof.

Governance-conditioned continuity relationships preserve memory participation across the multiple domains.

In some embodiments, previously established authoritative memory states are reused before additional computation is initiated.

The architecture therefore permits:
memory inheritance;
continuity reuse;
lineage reuse;
governance reuse;
association reuse;
or combinations thereof.

Accordingly, memory participation may reduce repeated computational reconstruction.

In some embodiments, operational realities are first evaluated according to memory participation.

Previously established authoritative memory states participate before generation of new memory structures whenever appropriate continuity relationships exist.

Accordingly, the architecture prefers memory inheritance before repeated reconstruction while preserving governance-conditioned admissibility and continuity relationships.

The disclosed architecture is not limited to artificial-intelligence systems.

However, artificial-intelligence systems, large language models, agent systems, retrieval systems, autonomous systems, knowledge systems, recommendation systems, reasoning systems, simulation systems, and combinations thereof may participate within governance-conditioned memory-state formation relationships.

The disclosed architecture distinguishes authoritative memory states from generated outputs, predicted outputs, inferred outputs, retrieved outputs, candidate outputs, and reasoning outputs.

Accordingly, memory participation remains governance-conditioned regardless of the source of the participating information.

In some embodiments, a large language model participates as a candidate-generation structure.

The large language model may generate:
responses;
recommendations;
predictions;
summaries;
interpretations;
plans;
reasoning outputs;
or combinations thereof.

The generated outputs do not automatically constitute authoritative memory states.

The generated outputs first participate as candidate structures.

Governance relationships determine admissibility.

Only admitted participation relationships may participate within authoritative memory-state formation.

Accordingly, generated outputs remain distinct from authoritative memory states.

In some embodiments, retrieval systems provide candidate participation structures.

Retrieved information may comprise:
documents;
records;
events;
measurements;
knowledge structures;
memory structures;
or combinations thereof.

Retrieved information does not automatically constitute authoritative memory states.

Retrieved information participates as candidate information.

Governance relationships determine admissibility.

Memory formation occurs only after governance-conditioned participation determination.

Accordingly, retrieval does not define memory.

In some embodiments, one or more agents participate within governance-conditioned memory-state formation relationships.

Agents may comprise:
software agents;
artificial-intelligence agents;
autonomous agents;
robotic agents;
human-assisted agents;
or combinations thereof.

Agent outputs participate as candidate structures.

Governance relationships determine admissibility.

Only admitted participation relationships become authoritative memory participation relationships.

Accordingly, agents do not possess authority merely because outputs are generated.

In some embodiments, multiple agents participate within memory-state formation relationships.

A first agent may generate a first candidate.

A second agent may generate a second candidate.

A third agent may generate a third candidate.

Governance relationships determine admissibility according to the candidate participation relationships.

The resulting admitted structures participate in authoritative memory-state formation.

Accordingly, memory formation remains governance-conditioned even when multiple agents participate.

In some embodiments, artificial-intelligence reasoning participates according to authoritative memory states.

Authoritative memory states operate as governance-conditioned reference structures.

Reasoning outputs participate as candidate structures.

Reasoning outputs may comprise:
predictions;
recommendations;
hypotheses;
simulations;
interpretations;
or combinations thereof.

Accordingly, reasoning outputs remain distinct from authoritative memory states until admitted through governance-conditioned admissibility relationships.

In some embodiments, previously established authoritative memory states are reused before initiation of additional artificial-intelligence reasoning.

Authoritative memory states may participate within:
reasoning relationships;
planning relationships;
simulation relationships;
recommendation relationships;
decision-support relationships;
or combinations thereof.

Accordingly, memory inheritance may occur before repeated reasoning.

This principle reduces repeated reconstruction of previously established realities.

In some embodiments, knowledge systems participate within governance-conditioned memory-state formation relationships.

Knowledge structures may comprise:
facts;
rules;
models;
principles;
relationships;
constraints;
or combinations thereof.

Knowledge structures do not automatically constitute authoritative memory states.

Knowledge structures participate as candidate structures.

Governance relationships determine admissibility.

Only admitted participation relationships become authoritative memory participation relationships.

Accordingly, knowledge remains governance-conditioned.

In some embodiments, knowledge evolution occurs through signed delta-state relationships.

An authoritative knowledge memory state may participate as a reference state.

Subsequent observations participate as positive delta-state relationships, negative delta-state relationships, directional delta-state relationships, or combinations thereof.

Governance relationships determine admissibility.

Memory evolution establishes future authoritative knowledge memory states.

Accordingly, knowledge evolution occurs through governance-conditioned memory evolution rather than direct replacement of prior knowledge.

In some embodiments, autonomous systems participate within governance-conditioned memory-state formation relationships.

Autonomous systems may comprise:
vehicles;
robots;
industrial systems;
infrastructure systems;
environmental systems;
or combinations thereof.

Operational memory states may be established prior to language generation.

Control memory participation may therefore occur before language memory participation.

Accordingly, memory formation remains independent of language formation.

In some embodiments, robotic systems establish governance-conditioned operational memory states.

Operational memory states preserve:
operational conditions;
environmental conditions;
tool conditions;
navigation conditions;
task conditions;
or combinations thereof.

Subsequent observations participate as signed delta-state relationships.

Memory evolution preserves continuity associated with robotic participation realities.

In some embodiments, simulations generate candidate participation structures.

Simulation outputs do not automatically constitute authoritative memory states.

Simulation outputs participate as candidate structures.

Governance relationships determine admissibility.

Admitted simulation participation relationships may participate within memory formation.

Accordingly, simulations remain subordinate to governance-conditioned memory-state formation.

In some embodiments, predictive systems generate candidate future-state structures.

Predicted future states do not automatically constitute authoritative memory states.

Predicted future states participate as candidate structures.

Governance relationships determine admissibility.

Only admitted participation relationships participate within future authoritative memory-state formation.

Accordingly, prediction remains distinct from authoritative memory formation.

In some embodiments, artificial-intelligence-generated outputs are treated as memory candidates rather than authoritative memory states.

The memory candidates participate within:
association formation;
governance determination;
admissibility determination;
memory formation;
or combinations thereof.

Accordingly, generation does not imply admission.

In some embodiments, authority is established through governance-conditioned admissibility relationships.

Generation does not establish authority.

Prediction does not establish authority.

Retrieval does not establish authority.

Reasoning does not establish authority.

Simulation does not establish authority.

Authority is established only through governance-conditioned admission.

Accordingly, authoritative memory states remain distinguishable from candidate participation structures.

In some embodiments, artificial-intelligence participation occurs according to a memory-first constitutional model.

Authoritative memory states participate before generation of future authoritative memory states.

Memory participation precedes reasoning participation.

Memory inheritance precedes repeated reconstruction.

Governance-conditioned memory formation precedes memory evolution.

Accordingly, artificial-intelligence participation remains subordinate to governance-conditioned memory-state formation and memory evolution relationships rather than defining memory independently.

The disclosed architecture is not restricted to a particular operational domain.

Authoritative memory states, signed delta-state relationships, association relationships, governance relationships, admissibility relationships, memory structures, memory-evolution relationships, continuity relationships, lineage relationships, and future authoritative memory-state formation relationships may participate across heterogeneous operational domains.

The operational domains may comprise:
human domains;
artificial-intelligence domains;
communication domains;
software domains;
hardware domains;
industrial domains;
robotic domains;
environmental domains;
medical domains;
transportation domains;
military domains;
energy domains;
knowledge domains;
or combinations thereof.

Accordingly, the disclosed architecture permits governance-conditioned memory participation across heterogeneous operational realities.

In some embodiments, a first operational domain establishes a first authoritative memory state.

A second operational domain establishes a second authoritative memory state.

A third operational domain establishes a third authoritative memory state.

Governance-conditioned relationships preserve participation continuity among the domains.

Signed delta-state relationships may be determined across the multiple domains.

Associations may be established across the multiple domains.

Memory evolution may therefore occur according to governance-conditioned cross-domain participation relationships.

In some embodiments, human participants establish authoritative memory states through governance-conditioned participation relationships.

Subsequent observations participate as signed delta-state relationships.

Associations preserve contextual relationships, event relationships, operational relationships, governance relationships, continuity relationships, and lineage relationships.

Memory evolution preserves continuity associated with human participation realities.

Accordingly, the architecture supports governance-conditioned human memory participation.

In some embodiments, artificial-intelligence systems participate as candidate-generation structures.

Artificial-intelligence-generated outputs participate as candidate participation relationships.

Governance relationships determine admissibility.

Admitted participation relationships become authoritative memory participation relationships.

Memory evolution occurs according to governance-conditioned participation relationships rather than generation alone.

In some embodiments, communication systems establish authoritative memory states associated with communication participation.

Subsequent communication events participate as signed delta-state relationships.

Associations preserve:
communication continuity;
network continuity;
operational continuity;
event continuity;
or combinations thereof.

Memory evolution preserves communication participation realities.

In some embodiments, communication participation occurs through multiple communication bearers.

The communication bearers may comprise:
Ethernet;
Wi-Fi;
Wi-Fi Mesh;
Bluetooth;
Bluetooth Mesh;
Thread;
Matter;
Zigbee;
LoRa;
6LoWPAN;
MQTT;
CoAP;
BACnet;
RS-485;
Modbus;
optical communication systems;
acoustic communication systems;
satellite communication systems;
future communication systems;
or combinations thereof.

Authoritative memory states remain independent of the communication bearer through which participation occurs.

Accordingly, memory participation remains governance-conditioned rather than bearer-conditioned.

In some embodiments, software systems establish authoritative memory states associated with software participation realities.

Signed delta-state relationships preserve software evolution relationships.

Associations preserve execution relationships, operational relationships, governance relationships, continuity relationships, and lineage relationships.

Memory evolution preserves software participation continuity.

In some embodiments, hardware systems establish authoritative memory states associated with hardware participation realities.

Subsequent observations participate as signed delta-state relationships.

Governance-conditioned memory evolution preserves hardware continuity relationships.

Accordingly, memory evolution may occur according to hardware participation realities.

In some embodiments, industrial systems establish authoritative memory states associated with industrial operations.

Operational observations participate as signed delta-state relationships.

Associations preserve:
equipment relationships;
maintenance relationships;
operational relationships;
environmental relationships;
continuity relationships;
or combinations thereof.

Memory evolution preserves industrial continuity while permitting governance-conditioned operational evolution.

In some embodiments, robotic systems establish authoritative memory states associated with robotic participation realities.

Operational memory states may be established prior to language generation.

Control memory participation therefore precedes language participation.

Subsequent observations participate as signed delta-state relationships.

Memory evolution preserves robotic continuity relationships.

In some embodiments, environmental systems establish authoritative memory states associated with environmental participation realities.

Environmental observations participate as signed delta-state relationships.

Associations preserve environmental continuity relationships.

Memory evolution preserves environmental participation continuity while permitting governance-conditioned environmental evolution.

In some embodiments, energy systems establish authoritative memory states associated with energy participation realities.

Operational observations participate as signed delta-state relationships.

Associations preserve:
load relationships;
generation relationships;
distribution relationships;
continuity relationships;
or combinations thereof.

Memory evolution preserves energy participation continuity.

In some embodiments, transportation systems establish authoritative memory states associated with transportation participation realities.

Subsequent observations participate as signed delta-state relationships.

Associations preserve:
vehicle relationships;
route relationships;
operational relationships;
environmental relationships;
continuity relationships;
or combinations thereof.

Memory evolution preserves transportation continuity relationships.

In some embodiments, medical systems establish authoritative memory states associated with physiological participation realities.

Subsequent observations participate as signed delta-state relationships.

Associations preserve:
patient relationships;
observation relationships;
equipment relationships;
environmental relationships;
continuity relationships;
or combinations thereof.

Memory evolution preserves physiological continuity relationships.

In some embodiments, military systems establish authoritative memory states associated with operational participation realities.

Operational observations participate as signed delta-state relationships.

Associations preserve:
mission relationships;
operational relationships;
communication relationships;
continuity relationships;
lineage relationships;
or combinations thereof.

Memory evolution preserves mission continuity while permitting governance-conditioned operational evolution.

In some embodiments, knowledge systems establish authoritative memory states associated with knowledge participation realities.

Subsequent evidence participates as positive signed delta-state relationships, negative signed delta-state relationships, directional delta-state relationships, or combinations thereof.

Memory evolution preserves knowledge continuity while permitting governance-conditioned knowledge evolution.

In some embodiments, signed delta-state relationships originating from different operational domains participate within common governance relationships.

A first signed delta-state relationship may originate from a human domain.

A second signed delta-state relationship may originate from an artificial-intelligence domain.

A third signed delta-state relationship may originate from an industrial domain.

Governance relationships may be determined according to relationships among the signed delta-state relationships.

Accordingly, memory evolution may occur across heterogeneous operational domains.

In some embodiments, future authoritative memory states are established according to cross-domain participation relationships.

Authoritative memory states originating from multiple domains may participate.

Signed delta-state relationships originating from multiple domains may participate.

Association relationships originating from multiple domains may participate.

Governance relationships originating from multiple domains may participate.

Admissibility relationships originating from multiple domains may participate.

Memory evolution therefore produces future authoritative memory states capable of preserving governance-conditioned continuity across heterogeneous operational realities.

In some embodiments, the disclosed architecture establishes a unified memory-first operational reality.

Authoritative memory states participate as constitutional reference structures.

Signed delta-state relationships participate as memory-evolution structures.

Associations participate as memory-formation structures.

Governance relationships participate as participation-determination structures.

Admissibility relationships participate as admission structures.

Memory evolution participates as continuity-preserving evolution structures.

Future authoritative memory states participate as subsequent constitutional reference structures.

Accordingly, heterogeneous operational domains may participate within a unified governance-conditioned memory evolution architecture while preserving continuity, lineage, admissibility, governance, and memory-first constitutional participation relationships.

In some embodiments, memory formation occurs prior to language formation.

Authoritative memory states may be established before generation of natural-language descriptions associated with those memory states.

Accordingly, language is not required for establishment of memory.

Language may subsequently represent memory.

Memory therefore exists independently of language participation.

In some embodiments, governance-conditioned memory structures participate within operational realities before language participation occurs.

Memory participation may occur through state participation, event participation, governance participation, continuity participation, lineage participation, or combinations thereof.

Accordingly, language participation is not required for memory participation.

In some embodiments, control memories are established before language memories.

Operational memories are established before semantic memories.

State memories are established before linguistic representations.

Accordingly, autonomous systems, industrial systems, robotic systems, infrastructure systems, environmental systems, artificial-intelligence systems, and other operational systems may establish authoritative memory states without requiring language generation.

In some embodiments, operational realities participate in memory formation before semantic interpretation occurs.

Semantic descriptions may be generated after operational memory formation.

Accordingly, semantic memory may derive from operational memory participation rather than define it.

In some embodiments, measurements alone do not constitute memory.

Signals alone do not constitute memory.

Stored values alone do not constitute memory.

Generated outputs alone do not constitute memory.

Retrieved information alone does not constitute memory.

Data becomes memory only after participation in governance-conditioned memory-state formation relationships.

Accordingly, memory is distinguished from storage.

In some embodiments, memory states comprise context relationships associated with time, location, participant, object, event, condition, source, environmental state, operational state, or combinations thereof.

Accordingly, memory preserves contextual participation relationships beyond underlying values.

In some embodiments, memory states comprise event relationships associated with observations, actions, interactions, operational occurrences, environmental occurrences, governance occurrences, or combinations thereof.

Accordingly, memory preserves event participation relationships rather than isolated values.

In some embodiments, memory formation comprises association relationships among multiple memory states.

Associations may be determined according to context relationships, event relationships, operational relationships, governance relationships, continuity relationships, lineage relationships, signed delta-state relationships, or combinations thereof.

Accordingly, memory participates as interconnected memory structures rather than isolated storage structures.

In some embodiments, an authoritative memory state participates as a baseline memory state.

The baseline memory state constitutes a governance-conditioned reference state.

Subsequent participation states may be determined relative to the baseline memory state.

In some embodiments, a subsequent participation state is associated with a positive signed delta-state relationship relative to an authoritative memory state.

Positive signed delta-state relationships may participate within governance determination, admissibility determination, memory formation, memory evolution, continuity preservation, lineage preservation, future authoritative memory-state formation, or combinations thereof.

In some embodiments, a subsequent participation state is associated with a negative signed delta-state relationship relative to an authoritative memory state.

Negative signed delta-state relationships may participate within governance determination, admissibility determination, memory formation, memory evolution, continuity preservation, lineage preservation, future authoritative memory-state formation, or combinations thereof.

In some embodiments, directional signed delta-state relationships are determined according to one or more positive signed delta-state relationships, one or more negative signed delta-state relationships, or combinations thereof.

In some embodiments, multiple signed delta-state relationships are determined relative to one or more authoritative memory states.

A first signed delta-state relationship may be determined.

A second signed delta-state relationship may be determined.

A third signed delta-state relationship may be determined.

Additional signed delta-state relationships may be determined.

In some embodiments, governance relationships are determined according to relationships among multiple signed delta-state relationships.

Participation authority may be determined according to relationships among multiple signed delta-state relationships.

Accordingly, governance may occur according to signed delta-state relationships rather than solely according to state existence.

In some embodiments, multiple signed delta-state relationships form a governed delta evolution matrix.

The governed delta evolution matrix participates within governance determination, admissibility determination, memory formation, memory evolution, continuity preservation, lineage preservation, and future authoritative memory-state formation.

Accordingly, memory evolution occurs through governance-conditioned signed delta-state participation rather than isolated state replacement.

In some embodiments, reasoning participation occurs according to one or more authoritative memory states.

Authoritative memory states participate as governance-conditioned constitutional reference structures.

Reasoning outputs do not automatically constitute authoritative memory states.

In some embodiments, reasoning outputs participate as memory candidates, state candidates, participation candidates, governance candidates, or combinations thereof.

Governance-conditioned admissibility relationships determine whether participation is permitted.

Accordingly, generated outputs remain distinct from authoritative memory states.

In some embodiments, authority is established through governance-conditioned admissibility relationships.

Generation does not establish authority.

Retrieval does not establish authority.

Prediction does not establish authority.

Simulation does not establish authority.

Reasoning does not establish authority.

Authority is established through governance-conditioned admission.

In some embodiments, previously established authoritative memory states are reused before initiation of additional computation.

Memory inheritance may therefore occur before repeated computational reconstruction.

Previously established authoritative memory states, continuity relationships, lineage relationships, governance relationships, association relationships, signed delta-state relationships, or combinations thereof may participate in subsequent memory formation relationships.

Accordingly, continuity preservation may reduce repeated computational reconstruction.

In some embodiments, natural-language expressions constitute one category of memory-expression forms.

Memory expressions may additionally comprise sensor expressions, operational expressions, state expressions, event expressions, signal expressions, image expressions, governance expressions, reality expressions, fact expressions, or combinations thereof.

Accordingly, language does not define memory.

Language represents memory.

The disclosed architecture therefore operates according to a memory-first constitutional model in which memory formation precedes language participation, memory participation precedes reasoning participation, authoritative memory states precede signed delta-state evolution, governance-conditioned memory formation precedes memory evolution, and future authoritative memory states are established according to governance-conditioned memory evolution relationships.

1. A governance-conditioned memory evolution system comprising:
an authoritative memory-state architecture configured to establish at least one authoritative memory state;
a signed delta-state architecture configured to determine one or more signed delta-state relationships relative to the at least one authoritative memory state;
an association-formation architecture configured to generate one or more associations according to the one or more signed delta-state relationships;
a governance architecture configured to determine governance relationships according to the one or more associations and the one or more signed delta-state relationships;
a memory-formation architecture configured to generate one or more memory structures according to the governance relationships, wherein the one or more associations constitute memory-formation inputs;
an admissibility architecture configured to determine admissibility according to the one or more memory structures and the one or more signed delta-state relationships;
a memory-evolution architecture configured to determine memory evolution according to the admissibility determination; and
a continuity architecture configured to preserve lineage continuity and reconstruction continuity associated with the at least one authoritative memory state.

2. The system of claim 1, wherein the signed delta-state relationships comprise positive delta-state relationships.

3. The system of claim 1, wherein the signed delta-state relationships comprise negative delta-state relationships.

4. The system of claim 1, wherein the signed delta-state relationships comprise positive delta-state relationships and negative delta-state relationships.

5. The system of claim 1, wherein a signed delta-state relationship is determined relative to a previously established authoritative memory state.

6. The system of claim 1, wherein a signed delta-state relationship is determined relative to multiple authoritative memory states.

7. The system of claim 1, wherein memory evolution is determined according to directional characteristics associated with one or more signed delta-state relationships.

8. A governance-conditioned delta-state governance system comprising:
at least one authoritative memory state;
multiple signed delta-state relationships associated with the at least one authoritative memory state;
an association-governance architecture configured to determine governance relationships according to associations generated from the multiple signed delta-state relationships;
a delta-to-delta governance architecture configured to determine governance relationships according to relationships among the multiple signed delta-state relationships;
an admissibility architecture configured to determine admissibility according to the governance relationships associated with the multiple signed delta-state relationships; and
a memory-formation architecture configured to generate one or more memory structures according to the admissibility determination.

9. The system of claim 8, wherein the multiple signed delta-state relationships comprise delta-to-delta comparison relationships.

10. The system of claim 8, wherein governance relationships are determined according to directional relationships among multiple signed delta-state relationships.

11. The system of claim 8, wherein governance relationships are determined according to positive delta-state relationships and negative delta-state relationships associated with different authoritative memory states.

12. The system of claim 8, wherein the multiple signed delta-state relationships form a governed delta matrix.

13. The system of claim 8, wherein admissibility is determined according to relationships among multiple signed delta-state relationships.

14. A governance-conditioned future-state formation system comprising:
an authoritative memory-state architecture configured to establish at least one authoritative memory state;
a signed delta-governance architecture configured to determine one or more signed delta-state relationships associated with the at least one authoritative memory state;
a causal association architecture configured to associate the one or more signed delta-state relationships with one or more cause relationships;
a memory-formation architecture configured to generate one or more memory structures according to the one or more cause relationships and the one or more signed delta-state relationships;
a memory-evolution architecture configured to determine memory evolution according to the one or more memory structures; and
a future authoritative-state architecture configured to establish a subsequent authoritative memory state according to the memory evolution and the one or more cause relationships.

15. The system of claim 14, wherein the one or more cause relationships comprise reason relationships.

16. The system of claim 14, wherein the one or more cause relationships comprise trigger relationships.

17. The system of claim 14, wherein the one or more cause relationships comprise provenance relationships.

18. The system of claim 14, wherein memory evolution comprises admissibility determination.

19. The system of claim 14, wherein memory evolution comprises reconstruction determination.

20. The system of claim 14, wherein the subsequent authoritative memory state is established according to governance-conditioned memory evolution associated with the one or more signed delta-state relationships and the one or more cause relationships.
